(19) United States
(12) Patent Application Publication
(10) Pub. No.: US 2025/0162047 A1
(43) Pub. Date: May 22, 2025

(54) MILLING CUTTER

(71) Applicants: Hyundai Motor Company, Seoul (KR); Kia Corporation, Seoul (KR)

(72) Inventors: Tae Jin Kim, Ulsan (KR); Ho Hwan Kim, Busan (KR); Jun Seok Choi, Daegu (KR); Min Kyu Shin, Busan (KR); Sang Uk Jeon, Ulsan (KR); Ho Gi Ju, Siheung-si (KR); Jeong Ho Yang, Daegu (KR); Jong Cheon Yoon, Siheung-si (KR); Dong Seok Kang, Seoul (KR); Hyub Lee, Seoul (KR)

(21) Appl. No.: 18/636,870

(22) Filed: Apr. 16, 2024

(30) Foreign Application Priority Data
Nov. 20, 2023 (KR) 10-2023-0161403

(51) Int. Cl. B23C 5/28

(52) U.S. Cl. CPC B23C 5/282

(57) ABSTRACT

An embodiment milling cutter includes a cutter body rotatable about a rotation axis, wherein the cutter body includes a coupling region disposed in an outer region of the cutter body based on a radial direction and a flow path configured to communicate with the outside and define a space in which a cooling fluid flows, and wherein at least a part of a region of the flow path is disposed to be directed toward the coupling region. The embodiment milling cutter further includes an insert member coupled to the coupling region of the cutter body.

### CROSS-REFERENCE TO RELATED APPLICATIONS

This application claims the benefit of Korean Patent Application No. 10-2023-0161403, filed on Nov. 20, 2023, which application is hereby incorporated herein by reference.

### TECHNICAL FIELD

The present disclosure relates to a milling cutter.

### BACKGROUND

Milling cutters are configured to machine materials while rotating about rotary shafts. There are various types of milling cutters that may be classified depending on structures or operating methods thereof. For example, the milling cutter may be configured such that a replaceable machining component is coupled to a cutter body portion coupled to the rotary shaft and machines a material. The machining component of the milling cutter having the above-mentioned shape needs to be consistently replaced because the machining component is abraded as a machining process is repeated.

Meanwhile, one of the factors which affect the lifespan of the machining component of the milling cutter having the above-mentioned structure is a cooling fluid that performs cooling and lubrication functions. In general, the cooling fluid is supplied into the cutter body portion of the milling cutter and then sprayed to a region in which the machining process is performed, such that the cooling fluid serves to cool and lubricate the region in which the machining component performs the machining process.

However, in the related art, the cooling and lubrication efficiency implemented by the cooling fluid is low, which causes a problem in that the machining component is quickly abraded, and the lifespan of the machining components is short.

### SUMMARY

The present disclosure relates to a milling cutter. Particular embodiments relate to a milling cutter having a flow path in which a cooling fluid flows.

Embodiments of the present disclosure have been made in an effort to manufacture a milling cutter with a novel structure capable of having a structure that further improves the cooling and lubrication efficiency implemented by a cooling fluid in comparison with the related art.

One embodiment of the present disclosure provides a milling cutter including a cutter body configured to be rotatable about a rotation axis A and an insert member coupled to an outer portion of the cutter body, in which the cutter body includes a coupling region provided in an outer region of the cutter body based on a radial direction R so that the insert member is coupled to the coupling region, in which the cutter body has a flow path configured to communicate with the outside and to define a space in which a cooling fluid flows, and in which at least a part of a region of the flow path, which communicates with the outside, is provided to be directed toward the coupling region.

The flow path may include a region having a curved shape.

The entire flow path may have a curved shape.

A first end portion of the flow path, which communicates with the outside, may be provided in an inner surface based on the radial direction R, and a second end portion of the flow path, which communicates with the outside, may be provided in an outer surface based on the radial direction R.

The flow path may include a first flow path section extending toward the inside of the cutter body from P0 that is the first end portion and a second flow path section extending toward the first flow path section from P2, which is the second end portion, and having P1, which is one end portion, connected to the first flow path section, and a curvature of the first flow path section and a curvature of the second flow path section may be different from each other.

The cutter body may further include a recess section provided in the outer surface based on the radial direction R and having a shape recessed inward in the radial direction R, and the recess section may include a first recess surface in which the coupling region is provided and a second recess surface in which one end portion of the second flow path section, which communicates with the outside, is provided.

An angle between the first recess surface and the radial direction R may be smaller than an angle between the second recess surface and the radial direction R.

A tangential line of a region, in which P2 is defined in the inner surface of the cutter body in which the second flow path section is defined, may be positioned in a space of a figure defined by a group of line segments that connect P2 and boundaries of the coupling region.

A plane defined by connecting P0, P1, and the coupling region may have a predetermined angle with respect to a plane perpendicular to the rotation axis A.

A plane defined by connecting P0, P2, and the coupling region may have a predetermined angle with respect to a plane perpendicular to the rotation axis A.

A plane defined by connecting P0, P1, and the coupling region may be consistent with a plane defined by connecting P0, P2, and the coupling region.

A diameter D of the flow path may be 0.5 mm or more and 2 mm or less, and an angle β defined between a plane defined by connecting P0, P1, and the coupling region and a plane perpendicular to the rotation axis A may be 0 degrees or more and 90 degrees or less.

A diameter D of the flow path may be more than 2 mm and equal to or less than 5 mm, and an angle β defined between a plane defined by connecting P0, P1, and the coupling region and a plane perpendicular to the rotation axis A may be 45 degrees or more and 90 degrees or less.

When the cutter body is cut in a direction perpendicular to a direction in which the flow path extends, a cross-section of the flow path may include a curved area section including a convex curved periphery and an apex area section configured to communicate with the curved area section and having a pointy shape.

The curved area section may have a part of a circular shape.

The apex area section may have a triangular shape.

The triangular shape may have an angle of 45 degrees or more in a region of the triangular shape connected to the curved area section.

A plane defined by connecting P0, P2, and the coupling region may be parallel to a part of the inner surface of the cutter body in which the apex area section is defined, or the plane defined by connecting P0, P2, and the coupling region may include a part of the inner surface.

In the coupling region, the insert member may be joined to the cutter body by brazing or welding.

The cutter body may be manufactured by a 3D printing method.

According to embodiments of the present disclosure, it is possible to manufacture the milling cutter with the novel structure capable of having the structure that further improves the cooling and lubrication efficiency implemented by the cooling fluid in comparison with the related art.

### BRIEF DESCRIPTION OF THE DRAWINGS

FIG. 1 is a perspective view illustrating a milling cutter according to embodiments of the present disclosure.

FIG. 2 is an enlarged perspective view illustrating the milling cutter according to embodiments of the present disclosure in a state in which a partial region of the milling cutter is cut away.

FIG. 3 is a first view illustrating a flow path and a periphery of the flow path provided in the milling cutter according to embodiments of the present disclosure when viewed at a first position.

FIG. 4 is a second view illustrating the flow path and the periphery of the flow path provided in the milling cutter according to embodiments of the present disclosure when viewed at a second position.

FIG. 5 is a third view illustrating the flow path and the periphery of the flow path provided in the milling cutter according to embodiments of the present disclosure when viewed at a third position.

FIG. 6 is a cross-sectional view illustrating a cross-sectional structure of the flow path provided in the milling cutter according to embodiments of the present disclosure.

FIG. 7 is a view illustrating a state in which thermal energy is emitted toward metal powder during a process of manufacturing the milling cutter according to embodiments of the present disclosure.

FIG. 8 is a view visually illustrating a flow path for a cooling fluid when the cooling fluid flows in the milling cutter according to embodiments of the present disclosure.

### DETAILED DESCRIPTION OF ILLUSTRATIVE EMBODIMENTS

Hereinafter, a milling cutter according to embodiments of the present disclosure will be described with reference to the drawings.

### Milling Cutter

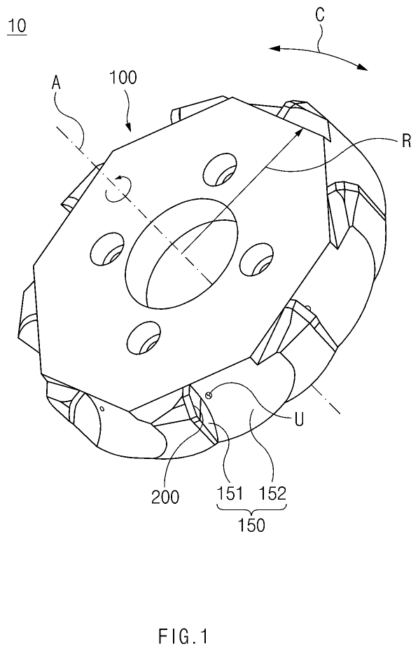

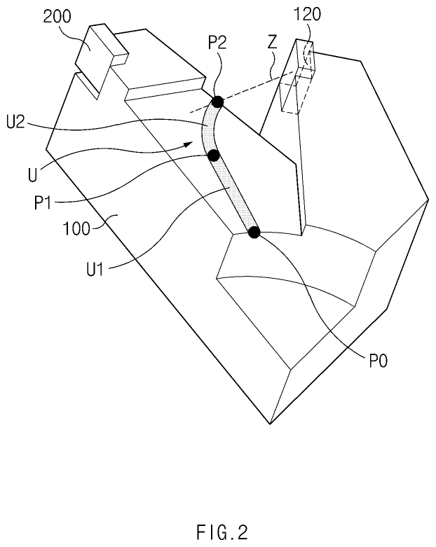

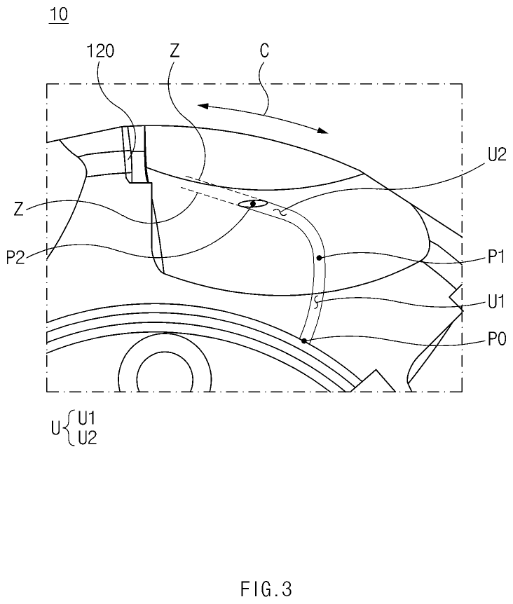

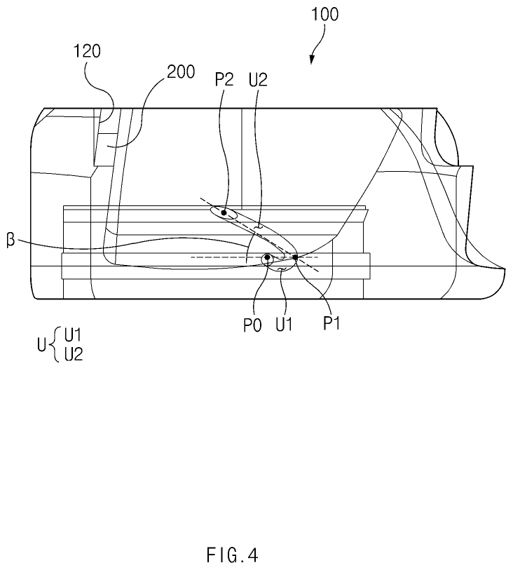

FIG. 1 is a perspective view illustrating a milling cutter according to embodiments of the present disclosure, and FIG. 2 is an enlarged perspective view illustrating the milling cutter according to embodiments of the present disclosure in a state in which a partial region of the milling cutter is cut away. FIG. 3 is a first view illustrating a flow path and a periphery of the flow path provided in the milling cutter according to embodiments of the present disclosure when viewed at a first position, and FIG. 4 is a second view illustrating the flow path and the periphery of the flow path provided in the milling cutter according to embodiments of the present disclosure when viewed at a second position.

With reference to FIGS. 1 to 4, a milling cutter 10 according to embodiments of the present disclosure may include a cutter body 100 configured to be rotatable about a rotation axis A and insert members 200 coupled to an outer portion of the cutter body 100. More specifically, the cutter body 100 may rotate about the rotation axis A by receiving power from the outside. The insert member 200 coupled to the cutter body 100 may come into contact with a material, which is intended to be machined, and machine the material. Because the detailed contents related to the method of operating the milling cutter are widely known in the related art, the description of the detailed contents will be omitted from the present specification. In the present specification, the description will be focused on differences from the related art.

With reference to FIGS. 1 to 4, the cutter body 100 may include coupling regions 120 provided in an outer region of the cutter body 100 in a radial direction R so that the insert members 200 are coupled to the coupling regions 120. Meanwhile, in the present specification, the radial direction R merely means a direction radially extending from the rotation axis A that is a central axis about which the cutter body 100 rotates. However, this does not mean that the milling cutter or the cutter body has a circular plate shape.

Meanwhile, according to embodiments of the present disclosure, the cutter body 100 may have a flow path U configured to communicate with the outside and to define a space in which the cooling fluid may flow. More specifically, the cooling fluid is supplied into the cutter body 100 through one end of the flow path U and then discharged back to the outside, such that the cooling fluid is supplied to a region in which the material is machined. Therefore, the cooling fluid may lubricate and cool the cutter body 100 and the material being machined.

In particular, according to embodiments of the present disclosure, the milling cutter 10 may have a structure in which the fluid, which is supplied into the cutter body 100, may be sprayed directly to the insert member 200 that comes into direct contact with the material during the machining process. In order to provide the above-mentioned structure, according to embodiments of the present disclosure, at least a part of a region, in which the flow path U of the cutter body 100 communicates with the outside, may be provided to be directed toward the coupling region 120. Hereinafter, a detailed shape of the flow path will be described.

With reference to FIGS. 1 to 4, the flow path U may include a region having a curved shape. For example, the entire flow path U may have a curved shape. However, alternatively, the flow path U may include both a straight region and a curved region.

More specifically, two regions of the flow path U may communicate with the outside. For example, as illustrated in FIGS. 2 and 3, a first end portion of the flow path U, which communicates with the outside, may be provided in an inner surface of the cutter body 100 based on the radial direction R, and a second end portion of the flow path U, which is provided separately from the first end portion and communicates with the outside, may be provided in an outer surface of the cutter body 100 based on the radial direction R. Hereinafter, the first end portion is denoted by P0, and the second end portion is denoted by P2.

Meanwhile, the flow path U may be divided into a plurality of sections. More specifically, as illustrated in FIGS. 2 to 4, the flow path may include a first flow path section U1 extending toward the inside of the cutter body 100 from P0, i.e., the first end portion, and a second flow path section U2 extending toward the first flow path section U1 from P2, i.e., the second end portion and having one end portion, i.e., P1 connected to the first flow path section U1. That is, P1 may be a point at which the first flow path section U1 and the second flow path section U2 are connected.

Meanwhile, for example, a curvature of the first flow path section U1 and a curvature of the second flow path section U2 may be different from each other. In this case, in embodiments of the present specification, the curvature of the first flow path section U1 and the curvature of the second flow path section U2 may be respectively understood as an average curvature of the first flow path section U1 and an average curvature of the second flow path section U2.

In addition, for example, as illustrated in FIGS. 2 to 4, the flow path U may have a shape convex only in one direction. It may be understood that no inflection point is present. However, alternatively, the flow path U may have an inflection point.

With reference to FIG. 1, the cutter body 100 may further include recess sections 150 provided in an outer surface of the cutter body 100 based on the radial direction R, each having a shape recessed inward in the radial direction R. More specifically, the recess sections 150 may be provided as a plurality of recess sections 150 provided in a circumferential direction C of the rotation axis A. More particularly, the plurality of recess sections 150 may be provided at equal intervals in the circumferential direction C, and the shapes of the recess sections 150 may be identical or correspond to one another. In this case, the cutter body 100 may have a shape approximately similar to a serrated shape.

The recess section 150 may be divided into a plurality of surfaces. More specifically, the recess section 150 may include a first recess surface 151 in which the coupling region 120 is provided and a second recess surface 152 in which one end portion of the second flow path section U2, i.e., P2, which is the second end portion and communicates with the outside, is provided. In this case, the first recess surface 151 and the second recess surface 152 may be provided to have a predetermined angle therebetween without being parallel to each other. In this case, according to embodiments of the present disclosure, an angle between the first recess surface 151 and the radial direction R may be smaller than an angle between the second recess surface 152 and the radial direction R. It may be understood that the second recess surface 152 is provided to be relatively parallel to the circumferential direction C in comparison with the first recess surface 151.

Meanwhile, as described above, at least a part of the region, in which the flow path U of the cutter body 100 communicates with the outside, may be provided to be directed toward the coupling region 120. This is to allow at least a part of the cooling fluid, which is discharged from the flow path U, to be sprayed to the coupling region 120 and the insert member 200 coupled to the coupling region 120.

To this end, with reference to FIGS. 2 to 4, a tangential line Z of a region of the second flow path section U2, in which an end portion, which communicates with the outside, is defined (i.e., a region in which P2 is defined) in the inner surface of the cutter body 100 in which the second flow path section U2 is defined may be positioned in a space of a figure defined by a group of line segments that connect P2 and boundaries of the coupling region 120. That is, according to embodiments of the present disclosure, the tangential line, which is defined in an extension direction of the flow path U from P2 in the inner surface of the cutter body 100 in which the flow path U is defined, is directed toward the coupling region 120 and the insert member 200. Therefore, the cooling fluid discharged from the flow path U may directly reach the coupling region 120 and the insert member 200.

Meanwhile, according to embodiments of the present disclosure, the flow path U not only extends in the radial direction R and the circumferential direction C but also extends in the direction of the rotation axis A, such that the flow path U may have a three-dimensional shape as a whole.

In this case, the configuration in which the flow path U has the three-dimensional shape as a whole may be understood as a configuration in which an imaginary plane including the flow path U has a predetermined angle with respect to a plane perpendicular to the rotation axis A without being parallel to the plane perpendicular to the rotation axis A. More specifically, as illustrated in FIGS. 2 to 4, according to embodiments of the present disclosure, a plane defined by connecting P0, P1, and the coupling region 120 may have a predetermined angle β with respect to the plane perpendicular to the rotation axis A. A plane defined by connecting P0, P2, and the coupling region 120 may also have an angle β, which is equal to the predetermined angle, with respect to the plane perpendicular to the rotation axis A. That is, according to embodiments of the present disclosure, the plane defined by connecting P0, P1, and the coupling region 120 may be consistent with the plane defined by connecting P0, P2, and the coupling region 120. For example, the entire region of the flow path U may be consistent with or correspond to the plane defined by connecting P0, P1, and the coupling region 120 and the plane defined by connecting P0, P2, and the coupling region 120. In this case, the flow path U has a three-dimensional shape, whereas the plane has a two-dimensional shape. Therefore, the statement that a three-dimensional shape is consistent with a two-dimensional shape may be strictly mathematically incorrect. Therefore, in embodiments of the present specification, the configuration in which the entire region of the flow path U is consistent with or corresponds to the plane defined by connecting P0, P1, and the coupling region 120 and the plane defined by connecting P0, P2, and the coupling region 120 may be defined as a configuration in which the entire length region of the flow path U is penetrated by the planes.

Meanwhile, a range of the angle β defined between the plane defined by connecting P0, P1, and the coupling region 120 (or the plane defined by connecting P0, P2, and the coupling region) and the plane perpendicular to the rotation axis A may vary depending on a diameter D of the flow path U. As described below, the entire cross-section of the flow path U does not have a circular shape, but only a partial region of the cross-section of the flow path U may have a part of a circular shape. In this case, the diameter of the flow path U may be understood as corresponding to a value that is twice a radius of curvature of a circumference of a curved line that defines a part of the circular shape.

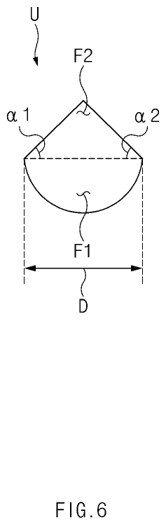

For example, the diameter D (see FIG. 6) of the flow path U may be 2 mm or less. In this case, the angle β defined between the plane defined by connecting P0, P1, and the coupling region 120 and the plane perpendicular to the rotation axis A may be 0 degrees or more and 90 degrees or less. In this case, for example, the diameter D of the flow path U may be 0.5 mm or more and 2 mm or less.

In contrast, the diameter D (see FIG. 6) of the flow path U may exceed 2 mm. In this case, the angle β defined between the plane defined by connecting P0, P1, and the coupling region 120 and the plane perpendicular to the rotation axis A may be 45 degrees or more and 90 degrees or less. For example, the diameter D of the flow path U may be more than 2 mm and equal to or less than 5 mm.

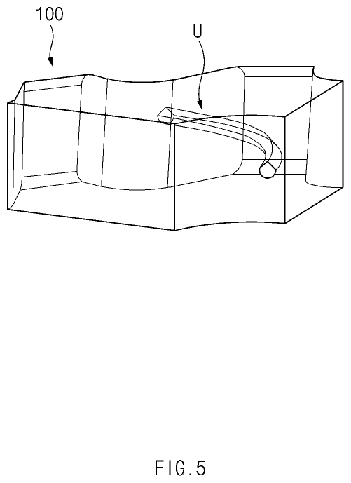

FIG. 5 is a third view illustrating the flow path and the periphery of the flow path provided in the milling cutter according to embodiments of the present disclosure when viewed at a third position, and FIG. 6 is a cross-sectional view illustrating a cross-sectional structure of the flow path provided in the milling cutter according to embodiments of the present disclosure.

As illustrated in FIGS. 5 and 6, a cross-section of the flow path U may not have a circular or elliptical shape. More specifically, in case that the cutter body 100 is cut in a direction perpendicular to a direction in which the flow path U extends, the cross-section of the flow path U may include a curved area section F1 including a convex curved periphery and an apex area section F2 configured to communicate with the curved area section F1 and having a pointy shape. That is, as illustrated in FIG. 6, the cross-section of the flow path U may have a shape in which a part thereof is pointy, and another part thereof is similar to a cross-section of a round water droplet. More specifically, the curved area section F1 may have a part of a circular shape, and the apex area section F2 may have a triangular shape. For example, the curved area section F1 may have a semicircular shape, and the apex area section F2 may have an isosceles triangular shape. In this case, values of α1 and α2 in FIG. 6 may be equal to each other. However, alternatively, the values of α1 and α2 in FIG. 6 may be different from each other. That is, the apex area section F2 may not have an isosceles triangular shape.

Meanwhile, in a case that the apex area section F2 has a triangular shape, the triangular shape may have an angle of 45 degrees or more in a region of the triangular shape connected to the curved area section F1.

The configuration in which the angle of the apex area section F2 is within the above-mentioned numerical value range may be based on the method of manufacturing the milling cutter 10 according to embodiments of the present disclosure, particularly, the method of manufacturing the cutter body 100.

According to embodiments of the present disclosure, the cutter body 100 of the milling cutter 10 may be manufactured by a 3D printing method. In particular, the milling cutter 10 may be made of metal. In this case, the milling cutter 10 may be manufactured by a 3D printing process of a power bed fusion (PBF) method of i) disposing metal powder on a plate, ii) solidifying the metal powder by supplying thermal energy to a partial region, and then iii) repeatedly disposing metal powder on the solidified metal powder.

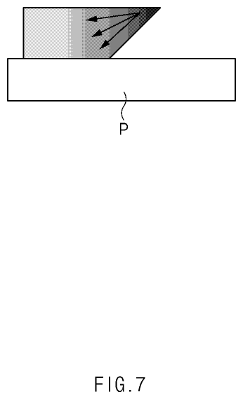

FIG. 7 is a view illustrating a state in which thermal energy is emitted toward metal powder during the process of manufacturing the milling cutter according to embodiments of the present disclosure.

Meanwhile, the thermal energy for solidifying the metal powder in the PBF method is emitted from a laser or electron beam. In this case, a cross-sectional shape of the flow path U is determined depending on an angle defined between a plate P and energy rays emitted to the metal powder from the laser or electron beams. As illustrated in FIG. 7, the reason is that in a case that the energy rays are emitted to the metal powder from the laser or electron beams, the metal powder in a region to which the energy rays are emitted, i.e., the metal powder in a region that the arrows in FIG. 7 reach, is solidified, whereas the metal powder in a region to which no energy ray is emitted, i.e., the metal powder in a region disposed below the region that the arrows in FIG. 7 reach, is not solidified, and the regions in which the metal powder is not solidified become the flow path U having an empty space later.

Meanwhile, it is necessary to smoothly discharge thermal energy to the outside during the process of solidifying the metal powder by emitting the thermal energy. The discharge of the thermal energy may be performed by thermal conduction between the plate P and the region in which the metal powder is solidified. However, in case that an angle defined between the energy rays, which are emitted from the laser or electron beams, and the plate P, on which the metal powder is disposed, is decreased, an overhang region, i.e., a region which is spaced apart from the plate P among the regions in which the metal powder is solidified, becomes distant from the plate P in a horizontal direction of the plate P. For this reason, because the heat discharge made by thermal conduction is not performed smoothly, the metal powder is partially sintered and adhered. This situation has a seriously adverse effect on the quality of the product manufactured by the PBF method. Therefore, in order to meet a predetermined requirement related to the quality of the cutter body 100 of the milling cutter 10 according to embodiments of the present disclosure, the angle between the energy rays and the plate needs to be within a predetermined range during the process of manufacturing the cutter body 100 by means of the PBF method.

Therefore, according to embodiments of the present disclosure, in the region of the triangular shape of the apex section area F2 connected to the curved area section F1, the triangular shape may have an angle of 45 degrees or more. More specifically, in the region of the triangular shape of the apex section area F2 connected to the curved area section F1, at least one of the two angles of the triangular shape may be 45 degrees or more. In a case that both of the two angles of the triangular shape have a value less than 45 degrees, heat cannot be properly discharged from the overhang region, which may degrade the quality of the cutter body. However, in a case that the angle of the triangular shape is excessively large in the region connected to the curved area section F1, the cross-sectional shape of the flow path U becomes abnormal. Therefore, it is necessary to appropriately restrict an upper limit of the angle. For example, the triangular shape may have an angle of 45 degrees or more and 60 degrees or less.

Meanwhile, according to embodiments of the present disclosure, the plane defined by connecting P0, P2, and the coupling region 120 may include a part of the inner surface of the cutter body 100 that defines the apex area section F2. For example, the plane defined by connecting P0, P2, and the coupling region 120 may include the inner surface of the cutter body 100 that defines a left region of the apex area section F2 based on FIG. 6.

Meanwhile, in the coupling region 120, the insert member 200 may be joined to the cutter body 100 by brazing or welding. This is to increase a joining force between the cutter body 100 and the insert member 200, thereby maximizing the durability and lifespan of the insert member 200 by minimizing vibration occurring on the insert member 200 during the process of operating the milling cutter 10.

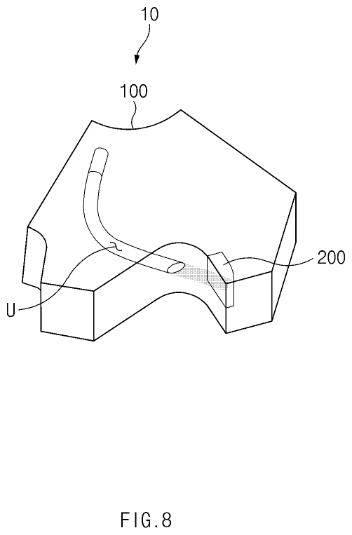

FIG. 8 is a view visually illustrating the flow path for the cooling fluid when the cooling fluid flows in the milling cutter according to embodiments of the present disclosure.

As illustrated in FIG. 8, according to embodiments of the present disclosure, the cooling fluid, which is discharged from the flow path U of the cutter body 100, may be sprayed directly to the insert member 200, which may effectively lubricate and cool the insert member 200.

Embodiments of the present disclosure have been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A milling cutter comprising:
a cutter body rotatable about a rotation axis, the cutter body comprising:
a coupling region disposed in an outer region of the cutter body based on a radial direction; and
a flow path configured to communicate with the outside and define a space in which a cooling fluid flows, wherein at least a part of a region of the flow path is disposed to be directed toward the coupling region; and
an insert member coupled to the coupling region of the cutter body.

2. The milling cutter of claim 1, wherein the flow path includes a region having a curved shape.

3. The milling cutter of claim 1, wherein an entirety of the flow path has a curved shape.

4. The milling cutter of claim 1, wherein the cutter body comprises a structure manufactured by a 3D printing method.

5. A milling cutter comprising:
a cutter body rotatable about a rotation axis, the cutter body comprising:
a coupling region disposed in an outer region of the cutter body based on a radial direction; and
a flow path configured to communicate with the outside and define a space in which a cooling fluid flows, wherein a part of a region of the flow path is disposed to be directed toward the coupling region, wherein a first end portion of the flow path is disposed in an inner surface based on the radial direction, and wherein a second end portion of the flow path is disposed in an outer surface based on the radial direction; and
an insert member coupled to the coupling region of the cutter body.

6. The milling cutter of claim 5, wherein the flow path comprises:
a first flow path section extending toward an inside of the cutter body from the first end portion; and
a second flow path section extending toward the first flow path section from the second end portion, the second flow path section including a first end point connected to the first flow path section, wherein a curvature of the first flow path section and a curvature of the second flow path section are different from each other.

7. The milling cutter of claim 6, wherein:
the cutter body further comprises a recess section provided in the outer surface based on the radial direction and having a shape recessed inward in the radial direction; and
the recess section comprises:
a first recess surface in which the coupling region is disposed; and
a second recess surface in which a second end point of the second flow path section, opposite the first end point, is disposed.

8. The milling cutter of claim 7, wherein an angle between the first recess surface and the radial direction is smaller than an angle between the second recess surface and the radial direction.

9. The milling cutter of claim 6, wherein a tangential line of a region, in which the second end portion of the flow path is defined in the inner surface of the cutter body in which the second flow path section is defined, is disposed in a space of a figure defined by a group of line segments that connect the second end portion of the flow path and boundaries of the coupling region.

10. The milling cutter of claim 6, wherein a plane defined by connecting the first end portion of the flow path, the first end point of the second flow path section, and the coupling region has a predetermined angle with respect to a plane perpendicular to the rotation axis.

11. The milling cutter of claim 6, wherein a plane defined by connecting the first end portion of the flow path, the second end portion of the flow path, and the coupling region has a predetermined angle with respect to a plane perpendicular to the rotation axis.

12. The milling cutter of claim 6, wherein a plane defined by connecting the first end portion of the flow path, the first end point of the second flow path section, and the coupling region is consistent with a plane defined by connecting the first end portion of the flow path, the second end portion of the flow path, and the coupling region.

13. The milling cutter of claim 6, wherein a diameter of the flow path is 0.5 mm or more and 2 mm or less, and wherein an angle defined between a plane defined by connecting the first end portion of the flow path, the first end point of the second flow path section, and the coupling region and a plane perpendicular to the rotation axis is 0 degrees or more and 90 degrees or less.

14. The milling cutter of claim 6, wherein a diameter of the flow path is more than 2 mm and equal to or less than 5 mm, and wherein an angle defined between a plane defined by connecting the first end portion of the flow path, the second end portion of the flow path, and the coupling region and a plane perpendicular to the rotation axis is 45 degrees or more and 90 degrees or less.

15. The milling cutter of claim 6, wherein in a view in which the cutter body is cut in a direction perpendicular to a direction in which the flow path extends, a cross-section of the flow path comprises:
a curved area section including a convex curved periphery; and
an apex area section configured to communicate with the curved area section and having a pointy shape.

16. The milling cutter of claim 15, wherein the curved area section has a part of a circular shape.

17. The milling cutter of claim 15, wherein the apex area section has a triangular shape.

18. The milling cutter of claim 17, wherein the triangular shape has an angle of 45 degrees or more in a region of the triangular shape connected to the curved area section.

19. The milling cutter of claim 15, wherein a plane defined by connecting the first end portion of the flow path, the second end portion of the flow path, and the coupling region is parallel to a part of the inner surface of the cutter body in which the apex area section is defined, or the plane defined by connecting the first end portion of the flow path, the second end portion of the flow path, and the coupling region includes a part of the inner surface.

20. A method of providing a milling cutter, the method comprising:
manufacturing a cutter body by a 3D printing method, the cutter body rotatable about a rotation axis, wherein the cutter body comprises:
a coupling region disposed in an outer region of the cutter body based on a radial direction; and
a flow path configured to communicate with the outside and define a space in which a cooling fluid flows, wherein at least a part of a region of the flow path is disposed to be directed toward the coupling region; and
joining an insert member to the cutter body by brazing or welding.
